(19) United States
(12) Patent Application Publication
(10) Pub. No.: US 2026/0186388 A1
(43) Pub. Date: Jul. 2, 2026

(54) GIMBAL STRUCTURE AND PHOTOGRAPHIC DEVICE

(71) Applicant: Shenzhen Xingyingda Industry Co., Ltd., Shenzhen (CN)

(72) Inventors: Jiawei HE, Shenzhen (CN); Dailin LI, Shenzhen (CN); Yan KE, Shenzhen (CN); Jun WANG, Shenzhen (CN)

(73) Assignee: Shenzhen Xingyingda Industry Co., Ltd., Shenzhen (CN)

(21) Appl. No.: 19/304,768

(22) Filed: Aug. 20, 2025

(30) Foreign Application Priority Data
Dec. 30, 2024 (CN) 202423306028.6

(51) Int. Cl. G03B 17/56

(52) U.S. Cl. CPC G03B 17/561

(57) ABSTRACT

A gimbal structure includes a gimbal body and a conversion assembly, and the gimbal body is formed with a mounting surface for mounting a quick-release plate. The conversion assembly includes a cam member and at least two conversion members, and the at least two conversion members are telescopically mounted on the mounting surface. The cam member is configured to drive any conversion member to extend out of the mounting surface.

### CROSS-REFERENCE TO RELATED APPLICATIONS

The present application claims priority to Chinese Patent Application No. 202423306028.6, filed on Dec. 30, 2024, the entire contents of which are incorporated herein by reference.

### TECHNICAL FIELD

The present application relates to the technical field of photographic gimbal, in particular to a gimbal structure and a photographic device.

### BACKGROUND

In the field of photography and videography, tripod heads are an important auxiliary device widely used in various shooting occasions. They not only provide a stable support platform, but also allow photographers to make precise adjustments to the camera position. Tripod heads are usually used in conjunction with camera quick-release plates to achieve quick loading and unloading and adjustment of the camera. In order to prevent the camera from falling during use, tripod heads are usually designed with anti-drop structures.

In the related art, most tripod heads use a latch structure or a screw structure as an anti-drop design. The mounting surface on the opening side of the gimbal structure is provided with a latch or hexagonal screw that is limited and matched with the retaining edge of the quick-release plate to prevent the camera and the quick-release plate from sliding out of the side of the gimbal structure. Since the latch position is fixed, these gimbal structures can only be adapted to quick-release plates of specific sizes and shapes, which limits the compatibility and applicability of the gimbal structure.

### SUMMARY

The present application is to provide a gimbal structure and a photographic device, aiming to solve the technical problem of limited compatibility and applicability of the gimbal structure in related technologies.

In order to achieve the above-mentioned purpose, the present application proposes a gimbal structure, which includes:
a gimbal body formed with a mounting surface for mounting a quick-release plate; and
a conversion assembly including a cam member and at least two conversion members.

The at least two conversion members are telescopically mounted at the mounting surface, and the cam member is configured to drive any one of the conversion members to extend out of the mounting surface.

In an embodiment, the cam member is movably provided at the gimbal body, and is provided with a protrusion; the gimbal body is provided with a plurality of guide holes communicated with the mounting surface, and each of the guide holes is staggered; each of the conversion members is telescopically mounted at one of the plurality of guide holes; and when the cam member moves, the cam member drives the protrusion to abut against and lift any of the conversion members to extend out of the mounting surface.

In an embodiment, the cam member includes a dial wheel, and a limiting groove and a first opening located at an edge of the gimbal body are provided at one side of the gimbal body; and the first opening is communicated with the limiting groove, the cam member is rotatably mounted in the limiting groove, and a part of the structure of the dial wheel is exposed at the first opening.

In an embodiment, a plurality of teeth are provided on at least a circumferential portion of the dial wheel exposed to the first opening in a circumferential side wall of the dial wheel.

In an embodiment, the cam member is mounted below the mounting surface, two slots are spaced apart at one side of the cam member facing the mounting surface, and the protrusion is connected between the two slots; and a connecting wall between each of the two slots and the protrusion is in an arc-shaped transition.

In an embodiment, the cam member is mounted below the mounting surface, two slots are spaced apart at one side of the cam member facing the mounting surface, and the protrusion is connected between the two slots; a connecting wall between each of the two slots and the protrusion is in an arc-shaped transition; a limiting groove is provided at one side of the gimbal body; and a side wall of the limiting groove facing each of the conversion members is recessed inwardly to form an arc surface, and the arc surface of the limiting groove and the two slots are enclosed to form a limiting space for limiting each of the conversion members.

In an embodiment, each of the conversion members further includes an elastic member, the elastic member is configured to push the each of the conversion members so that the conversion members have a tendency to retract; when the cam member drives any of the conversion members to extend out of the mounting surface, the conversion member is configured to overcome an elastic force and extend out of the mounting surface; and when the cam member does not drive the conversion members, the conversion members are configured to retract below the mounting surface under an action of the elastic force.

In an embodiment, the elastic member is sleeved on each of the conversion members, one end of the elastic member abuts against the mounting surface, and the other end of the elastic member abuts against each of the conversion members.

In an embodiment, the gimbal structure further includes a gimbal pressure block and gimbal knob, one end of the gimbal body is provided with a second opening, and the gimbal pressure block is exposed at the second opening; and a driving end of the gimbal knob is transmission-connected to the gimbal pressure block, and the gimbal knob is rotated to enable the gimbal pressure block to be engaged.

The present application further provides a photographic device, including:
the gimbal structure as described above;
a quick-release plate clamped and fixed with the gimbal structure; and
a tripod detachably connected to the gimbal structure.

The technical solution of the present application is to set a conversion assembly on one side of the gimbal body, and use the cam member in the conversion assembly to lift any of conversion members and push it out of the mounting surface. Compared with the fixed pin position or fixed hexagon screw position of the gimbal structure in the related art, the gimbal structure in the present application can lock with different retaining edge positions of multiple quick-release plates in at least two switching states of at least two conversion members, and can adapt to the sizes of different quick-release plates, thereby enhancing the wide applicability of the gimbal structure. The above-mentioned setting method allows the gimbal structure to be quickly adjusted to adapt to different devices and usage scenarios.

### BRIEF DESCRIPTION OF THE DRAWINGS

In order to more clearly illustrate the embodiments of the present application or the technical solutions in the related art, the drawings required for use in the description of the embodiments or the related art will be briefly introduced below. Obviously, the drawings described below are only some embodiments of the present application. For those skilled in the art, other drawings can be obtained based on the structures shown in these drawings without paying creative efforts.

FIG. 1 is a schematic structural view of a gimbal structure of the present application.

FIG. 2 is a schematic structural view of a conversion assembly according to an embodiment of the present application.

FIG. 3 is a top view of the gimbal structure in FIG. 1.

FIG. 4 is a schematic structural view of the conversion assembly according to another embodiment of a gimbal structure of the present application.

FIG. 5 is an exploded view of the gimbal structure of the present application.

FIG. 6 is a schematic structural view of a cam member movement according to an embodiment of the present application.

FIG. 7 is a schematic structural view of the cam member movement according to another embodiment of the present application.

FIG. 8 is a schematic structural view of a limiting space of the present application.

FIG. 9 is a schematic structural view of the gimbal structure and a quick-release plate of the present application in a clamped state.

FIG. 10 is a schematic structural view of a photographic device of the present application.

The realization of the purpose, functional features and advantages of the present application will be further explained in conjunction with embodiments and with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments of the present application, all other embodiments obtained by those skilled in the art without creative efforts are within the scope of the present application.

It should be noted that if the embodiments of the present application involve directional indications (such as up, down, left, right, front, back . . . ), the directional indications are only used to explain the relative position relationship, movement status, etc. between the components in a certain specific posture. If the specific posture changes, the directional indications will also change accordingly.

In addition, if there are descriptions involving “first”, “second”, etc. in the embodiments of the present application, the descriptions of “first”, “second”, etc. are only used for descriptive purposes and cannot be understood as indicating or implying their relative importance or implicitly indicating the number of technical features indicated. Therefore, the features limited to “first” and “second” may explicitly or implicitly include at least one of the features. In addition, if “and/or” appears in the full text, its meaning includes three parallel solutions. Taking “A and/or B” as an example, it includes solution A, solution B, or solutions that satisfy both A and B. In addition, the technical solutions between the various embodiments can be combined with each other, but it must be based on the ability of those skilled in the art to implement. When the combination of technical solutions is contradictory or cannot be implemented, it should be deemed that such combination of technical solutions does not exist and is not within the scope of the present application.

The present application provides a gimbal structure 1000.

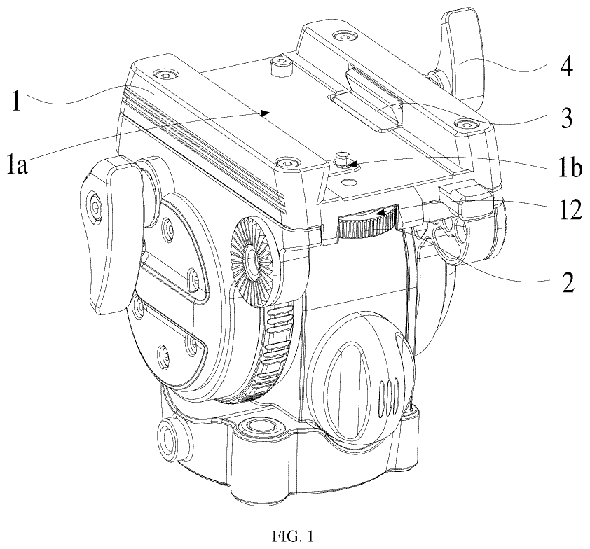

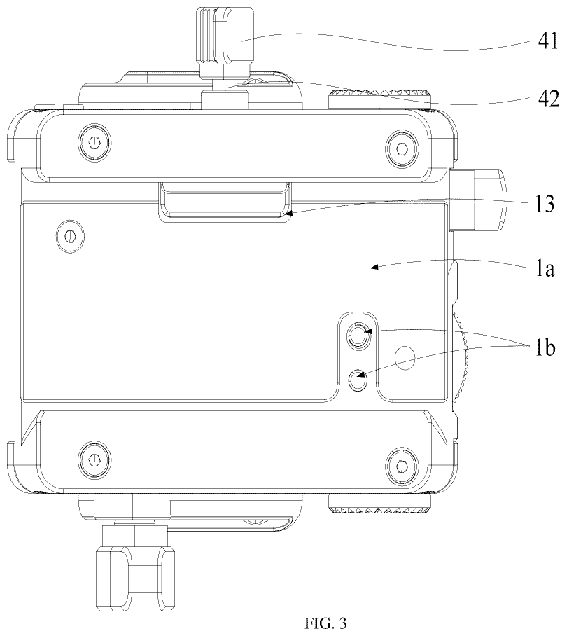

As shown in FIG. 1 to FIG. 10, in an embodiment of the present application, the gimbal structure includes a gimbal body 1 and a conversion assembly 2. The gimbal body 1 is formed with a mounting surface 1a for mounting a quick-release plate 2100. The conversion assembly 2 includes a cam member 21 and at least two conversion members 22, and the at least two conversion members 22 are telescopically or retracted mounted on the mounting surface 1a. The cam member 21 is configured to drive any of the conversion members 22 to extend out of the mounting surface 1a.

In this embodiment, the gimbal structure can be adapted to different quick-release plate 2100, and the usage scenarios are varied. The gimbal body 1 is configured to support and fix other components of the gimbal structure, and the mounting surface 1a is configured to mount the quick-release plate 2100. The outer wall of the gimbal body 1 can also be formed with a device for mounting a structure that matches the mounting surface 1a.

In an embodiment, they may be a dovetail groove and a dovetail plate for mating installation, and the mounting surface 1a can be the bottom surface or side surface of the dovetail groove. The present application uses the bottom surface as an embodiment to illustrate that more than two conversion members 22 can be telescopically mounted on the bottom surface of the dovetail groove, and at least one of the two or more conversion members 22 can selectively extend from the bottom surface to form a blocking position in a certain state for blocking a quick-release plate 2100 of corresponding specifications that matches the state of the blocking position. The cam member 21 is used to ensure that the protrusion 211 lifts the conversion members 22. Accordingly, the way in which the cam member 21 lifts the conversion members 22 includes but is not limited to manual, motor-driven, cylinder-driven, and other methods. The cam member 21 includes but is not limited to a dial wheel 213 with a protrusion 211 and a straight plate with a protrusion 211, which are not limited here.

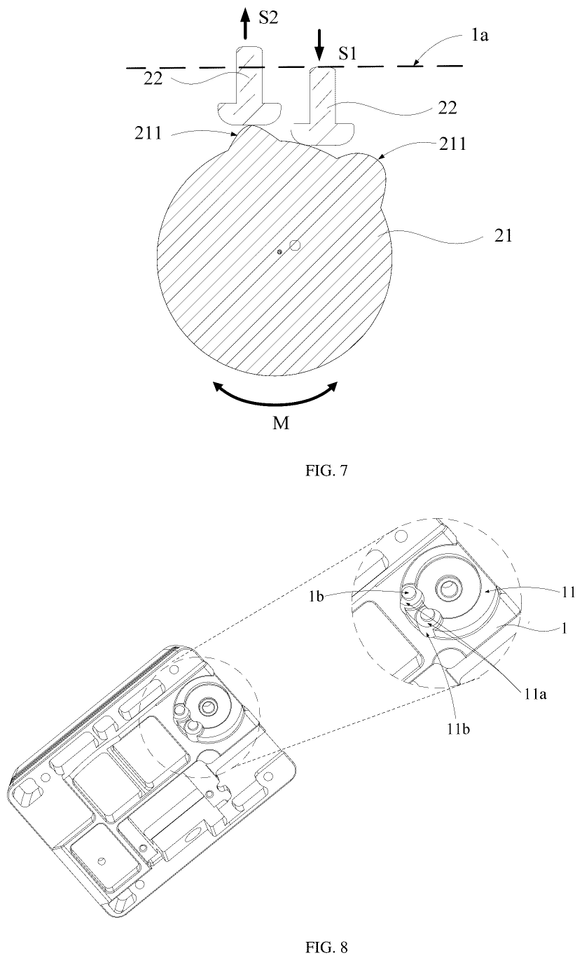

In conjunction with FIG. 6 and FIG. 7, the manner in which the cam member 21 is manually lifted includes but is not limited to rotation, linear movement, etc., which can be set according to requirements. The driving mode between the cam member 21 and the conversion members 22 includes contact driving and non-contact driving.

Taking the non-contact driving mode as an example, the cam member 21 can drive the cam member 21 to extend out of the mounting surface 1a by magnetic repulsion. A magnetic member is provided on a surface corresponding to the conversion members 22 and the cam member 21. The end of the conversion members 22 facing the cam member 21 and the end of the cam member 21 facing the conversion members 22 are both provided with the magnetic members of the same polarity. When the two move to the opposite surface of the cam member 21 and any conversion members 22, due to magnetic repulsion, the conversion member 22 extends out of the mounting surface 1a under the drive of the cam member 21. The conversion members 22 are configured to realize the snap-fitting or blocking between the gimbal structure and different quick-release plates 2100. The types of the conversion members 22 include but are not limited to the plunger-type conversion member 22 and the slider-type conversion member 22, and the conversion pin is preferably used here. It can be understood that the conversion members 22 are spaced apart along the movement direction of the cam member 21, that is, the conversion members 22 are neither overlapped nor interfered with each other along the movement direction of the cam member 21.

Therefore, when the cam member 21 drives any conversion member 22 to extend out of the mounting surface 1a, the conversion members 22 are spaced apart and staggered along the extension direction of the retaining edge of the quick-release plate, so that multiple locking can be realized on the mounting surface 1a under the drive of the cam member 21 to adapt to the installation of quick-release plates of different sizes.

The technical solution of the present application is to provide the conversion assembly 2 on one side of the gimbal body 1, and use the cam member 21 in the conversion assembly 2 to lift any conversion member 22 and push it out of the mounting surface 1a. Compared with the fixed pin position or fixed hexagonal screw position of the gimbal structure in the related art, the gimbal structure in the present application can realize locking with different positions of retaining edges or protruding portions of multiple quick-release plates 2100 in at least two switching states of at least two conversion members 22, and can adapt to different quick-release plates 2100 (the retaining edge position or protruding portion of difference quick-release plates are difference, such as the sizes or locations are difference), thereby enhancing the wide applicability of the gimbal structure. The above-mentioned configuration allows the gimbal structure to be quickly adjusted to adapt to different devices and usage scenarios.

In an embodiment of the present application, the cam member 21 is movably provided at the gimbal body 1, and the cam member 21 is provided with a protrusion 211. The gimbal body 1 is provided with a plurality of guide holes 1b communicated with the mounting surface 1a, and each guide hole 1b is staggered. Each conversion member 22 is telescopically mounted on the guide hole 1b. When the cam member 21 moves, it drives the protrusion 211 to abut against and lift any conversion member 22 to extend out of the mounting surface 1a.

In this embodiment, the cam member 21 is movably provided at the gimbal body 1, and is not limited to being provided below or on the side of the mounting surface 1a. The guide hole 1b is used to realize that the conversion member 22 is lifted by the protrusion 211 and protrudes from the mounting surface 1a. Accordingly, the guide holes 1b are arranged at intervals on the mounting surface 1a, and each conversion member 22 corresponds to the guide hole 1b. It can be understood that the guide holes 1b are arranged at intervals, that is, they are neither overlapped nor interfered with. The guide holes 1b are staggered along the direction perpendicular to the extension direction of the retaining edge of the quick-release plate. The protrusion 211 is protrudes from the surface of the cam member 21, and the connection between the protrusion 211 and the surface of the cam member 21 is in an arc-shaped transition to provide a smooth transition of the rotating member between the surface of the cam member 21 and the protrusion 211.

Correspondingly, each conversion member 22 can be lifted and lowered through a guide hole 1b. It can be understood that when the gimbal structure is used in conjunction with the quick-release plate 2100, the quick-release plate 2100 is mounted on the mounting surface 1a above the gimbal body 1, and the cam member 21 is moved so that the protrusion 211 of the cam member 21 contacts any conversion member 22, so that any conversion member 22 is lifted out of the guide hole 1b under the action of the protrusion 211, so that the mounting surface 1a provides abutment and limit when the quick-release plate 2100 is mounted. The movement method of the cam member 21 here includes but is not limited to manual and electric methods, which are not limited here and can be set according to the actual needs of the user. The manual method is preferred here for daily use.

As shown in FIG. 6, taking the linear movement method as an example, the cam member 21 moves left and right so that the protrusion 211 abuts against any conversion member 22 and lifts it out of the mounting surface 1a. Specifically, the working principle of the present application is that the cam member 21 moves to the left along the S direction in FIG. 6, driving the protrusion 211 on the cam member 21 to move, thereby lifting the conversion members 22 in the two slots 212 along the S2 direction in FIG. 6 and extending out of the mounting surface 1a, acting as a blocking block in the first state, while the other right conversion member 22 falls back along the S1 direction in FIG. 6 under the action of gravity or under the combined action of gravity and elastic force.

On the contrary, when the cam member 21 moves rightward along the S direction in FIG. 6, the conversion member 22 on the right side of the two conversion members 22 is lifted up and protrudes from the mounting surface 1a, and the conversion member 22 on the left side of the two conversion members 22 falls back, and forms a blocking block in another state, thereby being adaptable to two specifications of quick-release plates 2100. The position of the retaining edge set or protruding at the bottom of each specification of the quick-release plate 2100 corresponds to the position of the blocking block in the first state and the position of the blocking block in the second state above, thereby allowing the two specifications of the quick-release plate 2100 to be detachably mounted on the gimbal, and preventing the quick-release plate 2100 from excessively moving in the dovetail groove and sliding off the gimbal. The rotation method is shown in the following embodiment. The above-mentioned setting method can realize the rapid loading and unloading of the quick-release plate 2100 through the cooperation of the cam member 21 and the conversion members 22, thereby improving the use efficiency.

In an embodiment of the present application, the cam member 21 includes a dial wheel 213, and a limiting groove 11 and a first opening 12 located at the edge of the gimbal body 1 are provided on one side of the gimbal body 1. The first opening 12 is communicated with the limiting groove 11, and the cam member 21 is rotatably mounted in the limiting groove 11 and at least a part of the dial wheel 213 is exposed at the first opening 12, so it is convenient to touch and rotate the dial wheel 213.

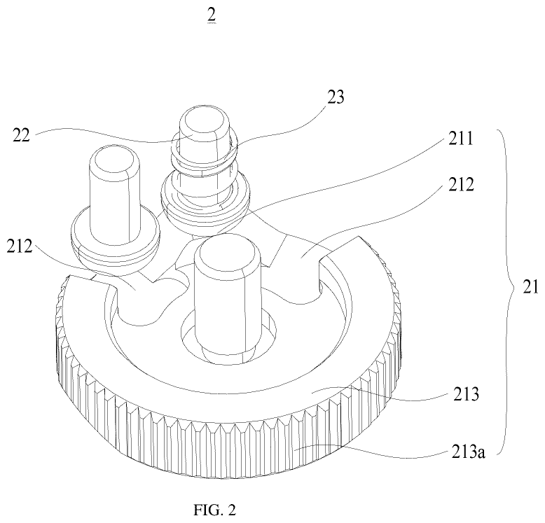

As shown in FIG. 2, in this embodiment, the present application adopts the method of manually rotating the dial wheel 213 to abut and lift any conversion member 22 protruding from the mounting surface 1a. The specific working principle is described in the following embodiment. In order to facilitate the user to quickly adjust the cam member 21 during the use of the gimbal structure, the first opening 12 simplifies the user's operation process, and facilitates the user to quickly find and rotate the dial wheel, thereby achieving the adjustment and adaptation of the gimbal structure and components such as the quick-release plate 2100. The limiting groove 11 is used to accommodate the dial wheel 213. Here, in order to facilitate people's daily use, the cam member 21 is manually adjustable and exposed at the first opening 12, so that people can quickly judge the state of the cam member 21 based on vision, thereby improving the accuracy and convenience of adjustment.

In an embodiment of the present application, a plurality of teeth 213a are provided on the circumferential sidewall of the dial wheel 213, at least on the circumferential portion of the dial wheel 213 exposed to the first opening 12.

As shown in FIG. 2, in this embodiment, it can be understood that the plurality of teeth 213a can be evenly distributed along the circumference of the dial wheel 213, or can be distributed only in the area exposed to the first opening 12. The above two settings are not limited and can be set by the user. Due to the presence of the teeth 213a, when the dial wheel rotates, the user can sense the accuracy of each dialing through the teeth 213a of the dial wheel. At the same time, it can effectively prevent the dial wheel from slipping or losing control when rotating. The above settings increase the contact surface and can better disperse the force.

In an embodiment of the present application, the cam member 21 is mounted below the mounting surface 1a. Two slots 212 are spaced apart on one side of the cam member 21 facing the mounting surface 1a. A protrusion 211 is connected between the two slots 212. The connecting wall between each slot 212 and the protrusion 211 is in an arc-shaped transition.

As shown in FIG. 2, in this embodiment, the cam member 21 is provided below the mounting surface 1a. In order to ensure the positioning effect of the cam member 21 after rotation, two slots 212 are provided on the surface of the cam member 21. The two slots 212 are provided on both sides of the protrusion 211 to form a concave-convex surface. Accordingly, when the protrusion 211 abuts against one of the conversion members 22, the other conversion member 22 is limited in the slot 212.

Further, in order for the conversion members 22 to smoothly switch between the protrusion 211 and the slots 212, the connecting wall between the slots 212 and the protrusion 211 is set to a curved surface transition, so that the contact between the cam member 21 and the conversion members 22 are more uniform, the control accuracy of the gimbal structure during the adjustment process is improved, and the impact resistance and stability of the structure are enhanced. In order to further limit the rotation angle of the cam member 21, the side edge of the slot 212 forms a retaining edge for limiting the rotation of the cam member 21. The retaining edge contacts the outer peripheral wall of the conversion member 22, so that the cam member 21 cannot continue to rotate. This effectively prevents the cam member 21 from over-rotating or exceeding the permitted working range, and at the same time allows the cam member 21 to stably rotate within the specified range, ensuring that the gimbal structure remains stable during use. The above arrangement achieves a smoother rotation transition and improves the stability of the gimbal structure.

In an embodiment of the present application, the cam member 21 is mounted below the mounting surface 1a, two slots 212 are spaced apart on one side of the cam member 21 facing the mounting surface 1a, and a protrusion 211 is located between the two slots 212. The connecting wall between each slot 212 and the protrusion 211 is in an arc-shaped transition. A limiting groove 11 is provided on one side of the gimbal body 1. The side wall of the limiting groove 11 facing each conversion member 22 is recessed inwardly to form an arc surface 11b, and the arc surface 11b of the limiting groove 11 and the slots 212 are enclosed to form a limiting space 11a for limiting each conversion member 22.

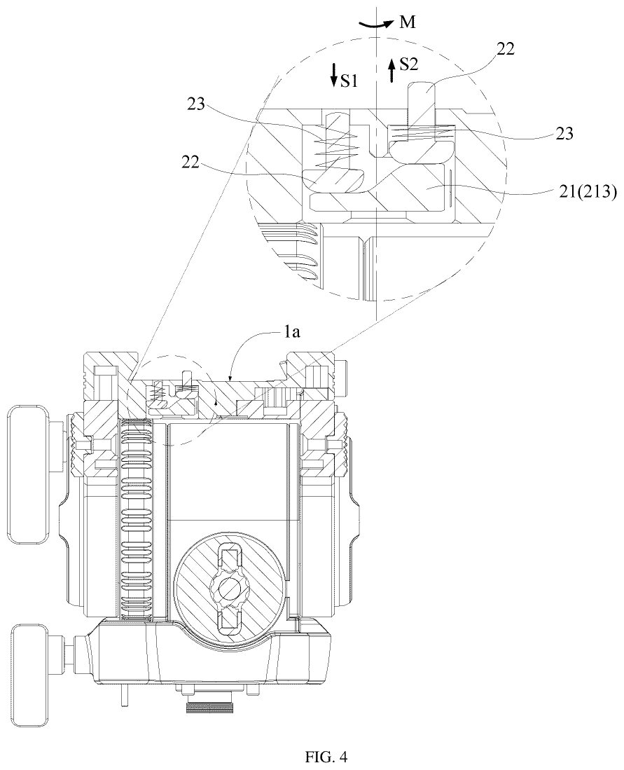

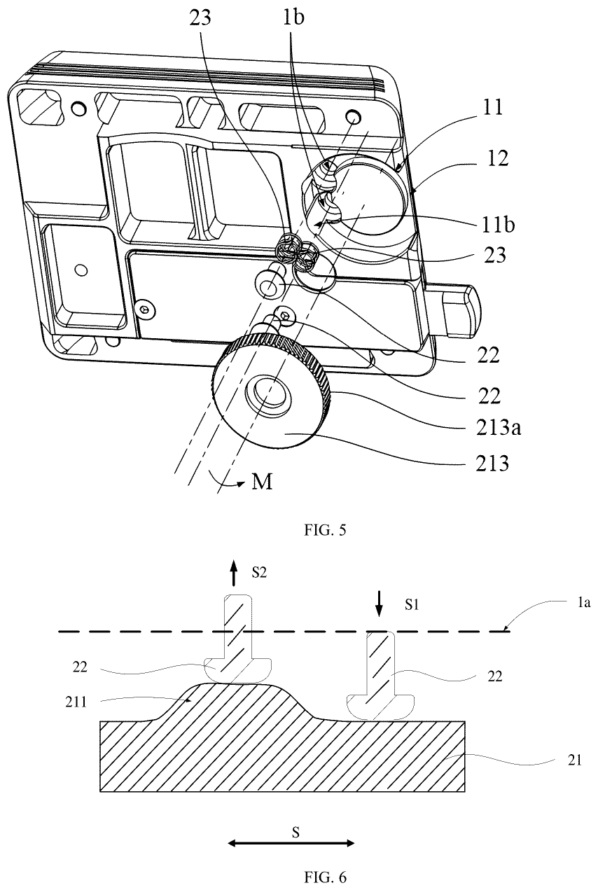

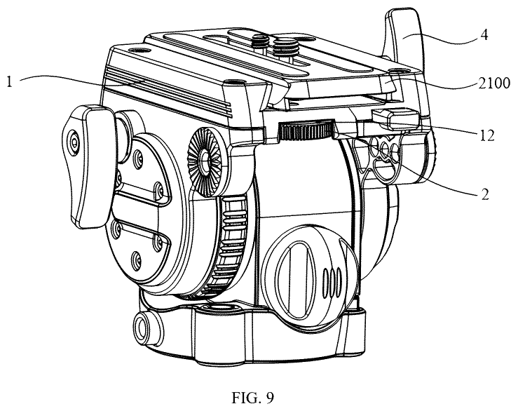

As shown in FIG. 2, FIG. 4, FIG. 5 and FIG. 8, in this embodiment, the arc surface 11b is configured to adapt to the shape of the conversion members 22 and effectively limit the range of motion of the conversion members 22, so that the moving path of the conversion members 22 are precisely controlled, thereby avoiding misoperation or unstable movement of the system. It can be understood that the limiting space 11a is communicated with the guide holes 1b. The existence of the limiting space 11a enables each movement of the conversion members 22 to reach a preset angle and position, thereby enhancing the adjustment accuracy of the gimbal structure.

In an embodiment of the present application, the conversion member 22 also includes an elastic member 23, which is used to push the conversion member 22 so that the conversion member 22 has a tendency to retract. When the cam member 21 drives any conversion member 22 to extend out of the mounting surface 1a, the conversion member 22 overcomes the spring force and extends out of the mounting surface 1a, and when the cam member 21 does not drive the conversion member 22, the conversion member 22 retracts below the mounting surface 1a under the action of the elastic force.

In this embodiment, the elastic member 23 includes but is not limited to a reed, a spring, etc. As shown in FIG. 4 and FIG. 5, the elastic member 23 is used to provide a positioning force to maintain the normal position of the two conversion members 22. Preferably, the elastic member 23 is in the form of a spring. It can be understood that when a conversion member 22 is converted from being aligned with the protrusion 211 to being aligned with the slot 212, the elastic member 23 applies a downward force so that the conversion member 22 is kept in the initial position and is not lifted up; when a conversion member 22 is converted from the being aligned with slot 212 to being aligned with the protrusion 211, that is, when the conversion member 22 is about to be located at the highest point of the protrusion 211, the elastic member 23 overcomes the external cam member 21 inclined surface force, allowing the conversion member 22 to move upward and switch to a new position. At the same time, during the rotation of the cam member 21, when the conversion member 22 is at the transition surface between the protrusion 211 and the slot 212, the action force of the elastic member 23 automatically presses the conversion member 22 downward to ensure that the conversion member 22 returns to the original position. Furthermore, when the conversion member 22 is converted between being aligned with the protrusion 211 and being aligned with the slot 212, the presence of the elastic member 23 can ensure that the corresponding conversion member 22 is pushed up or pressed down to prevent the two from colliding or overlapping. The above arrangement enables the conversion member 22 to automatically reset after the cam member 21 rotates, thereby ensuring the stability and reliability of the system.

In an embodiment of the present application, each elastic member 23 is sleeved on the conversion member 22, one end of the elastic member 23 abuts against the mounting surface 1a, and the other end of the elastic member 23 abuts against the conversion member 22.

In this embodiment, the elastic member 23 is preferably a spring. It can be understood that, taking the cam member 21 abutting against and rotating and lifting conversion member 22 as an example, as shown in FIG. 4 and the FIG. 7 which shows the working principle, the dial wheel 213 rotates around the axis of the dial wheel 213, driving the protrusion 211 on the dial wheel 213 to move, thereby lifting one of the conversion members 22 in the two slots 212 along the direction of S2 in FIG. 7 to extend out of the mounting surface 1a, taking a conversion member 22 as a blocking block in the first state while the other left conversion member 22 retracts along the direction of S1 in FIG. 7 under the action of gravity and/or spring force.

Conversely, when the dial wheel 213 rotates in the opposite direction around the axis of the dial wheel 213, the left-side conversion member 22 of the two conversion members 22 is lifted up and protrudes from the mounting surface 1a, and the right-side conversion member 22 of the two conversion members 22 is retracted to form a blocking block in another state, thereby being adaptable to two specifications of quick-release plates 2100. The positions of the retaining edges or protruding portions arranged at the bottom of each specification of the quick-release plate 2100 respectively correspond to the positions of the blocking blocks in the first state and the second state above, thereby the two specifications of the quick-release plates 2100 can be detachably mounted on the gimbal, and the quick-release plates 2100 can be prevented from excessively moving in the dovetail groove and sliding off the gimbal.

In an embodiment of the present application, the gimbal structure also includes a gimbal pressure block 3 and a gimbal knob 4. A second opening 13 is provided at one end of the gimbal body 1, and the gimbal pressure block 3 is exposed in the second opening 13. The driving end of the gimbal knob 4 is transmission-connected to the gimbal pressure block 3, and the gimbal knob 4 rotates to enable the gimbal pressure block 3 to engage.

In this embodiment, the gimbal pressure block 3 cooperates with the gimbal knob 4 to achieve locking of other components that cooperate with the gimbal structure. It can be understood that adjusting the gimbal knob 4 can lock or loosen the gimbal pressure block 3, and the locking of the components that cooperate with the gimbal structure is achieved by adjusting the gimbal pressure block 3. The above-mentioned setting method simplifies the installation operation and realizes quick fixation and release. Furthermore, the gimbal pressure block 3 is provided with a threaded hole, and the gimbal knob 4 includes a knob portion 41 and a connecting portion 42. The driving end of the knob portion 41 is connected to the connecting portion 42. The outer peripheral wall of the connecting portion 42 is provided with a thread that matches the threaded hole. The knob portion 41 rotates to allow the connecting portion 42 to extend into the threaded hole, and is used to control the opening of the gimbal pressure block 3.

When the gimbal knob 4 rotates, the force transmitted by the thread pushes the gimbal pressure block 3 to move axially on its mounting track, thereby changing the contact surface between the gimbal pressure block 3 and the components that cooperate with the gimbal structure. When the knob is rotated, the gimbal pressure block 3 moves closer to the components that cooperate with the gimbal structure, thereby increasing the fastening force and locking the connection between the gimbal structure and other components (such as the connection between the camera and the gimbal structure). The gimbal pressure block 3 moves away from the components that cooperate with the gimbal structure, thereby loosening the connection and facilitating the adjustment or disassembly of the device. The above arrangement enhances the locking capability.

The present application also proposes a photographic device 2000, which includes a quick-release plate 2100, a tripod and the above-mentioned gimbal structure 1000. The specific structure of the gimbal structure 1000 refers to the above-mentioned embodiment. Since the photographic device adopts all the technical solutions of all the above-mentioned embodiments, it at least has all the beneficial effects brought by the technical solutions of the above-mentioned embodiments, which will not be described one by one here. The gimbal structure 1000 is clamped and fixed with the quick-release plate 2100, and the gimbal structure 1000 is detachably connected with the tripod 2200.

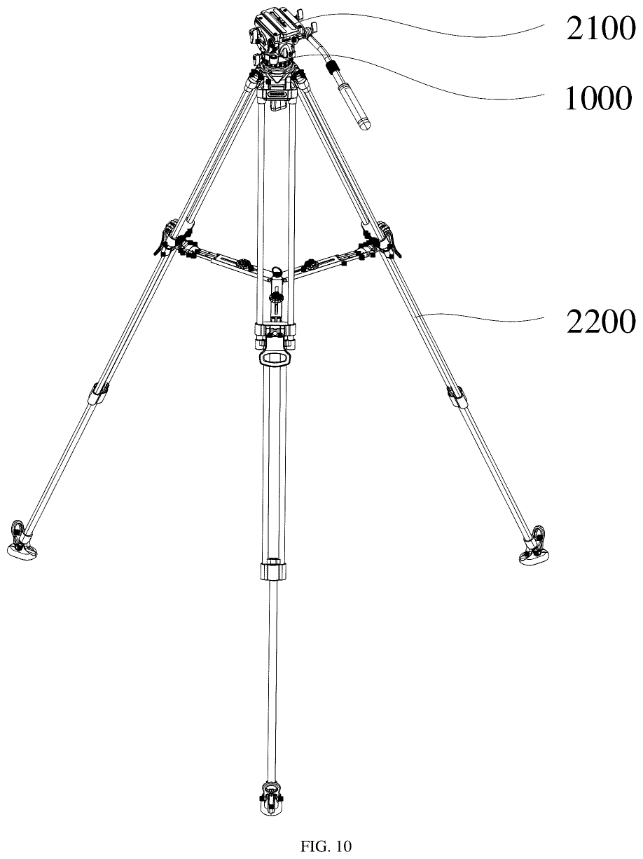

As shown in FIG. 9 and FIG. 10, in this embodiment, the gimbal structure 1000 is provided with a through slot for limiting the position of the quick-release plate 2100, and the gimbal pressure block 3 realizes the clamping connection with the edge of the quick-release plate 2100. The gimbal structure 1000 can be connected to the tripod 2200 by screw connection, clamping connection, etc. The above setting method realizes a fast and firm connection of the quick-release plate 2100, adapts to different shooting environments, and meets the needs of various shooting scenes.

The above description are only some embodiments of the present application, and do not limit the patent scope of the present application. All equivalent structural changes made by using the contents of the present application specification and drawings under the technical concept of the present application, or directly/indirectly applied in other related technical fields are included in the scope of the present application.

What is claimed is:

1. A gimbal structure, comprising:
a gimbal body formed with a mounting surface for mounting a quick-release plate; and
a conversion assembly comprising a cam member and at least two conversion members,
wherein the at least two conversion members are telescopically mounted at the mounting surface, and the cam member is configured to drive any one of the conversion members to extend out of the mounting surface.

2. The gimbal structure according to claim 1, wherein
the cam member is movably provided at the gimbal body, and is provided with a protrusion;
the gimbal body is provided with a plurality of guide holes communicated with the mounting surface, and each of the guide holes is staggered;
each of the conversion members is telescopically mounted at one of the plurality of guide holes; and
when the cam member moves, the cam member drives the protrusion to abut against and lift any of the conversion members to extend out of the mounting surface.

3. The gimbal structure according to claim 1, wherein
the cam member comprises a dial wheel, and a limiting groove and a first opening located at an edge of the gimbal body are provided at one side of the gimbal body; and
the first opening is communicated with the limiting groove, the cam member is rotatably mounted in the limiting groove, and a part of the dial wheel is exposed at the first opening.

4. The gimbal structure according to claim 3, wherein a plurality of teeth are provided on at least a circumferential portion of the dial wheel exposed to the first opening in a circumferential side wall of the dial wheel.

5. The gimbal structure according to claim 1, wherein
the cam member is mounted below the mounting surface, two slots are spaced apart at one side of the cam member facing the mounting surface, and the protrusion is located between the two slots; and
a connecting wall between each of the two slots and the protrusion is in an arc-shaped transition.

6. The gimbal structure according to claim 2, wherein:
the cam member is mounted below the mounting surface, two slots are spaced apart at one side of the cam member facing the mounting surface, and the protrusion is located between the two slots;
a connecting wall between each of the two slots and the protrusion is in an arc-shaped transition;
a limiting groove is provided at one side of the gimbal body; and
a side wall of the limiting groove facing each of the conversion members is an arc surface, and the arc surface of the side wall of the limiting groove and the two slots are enclosed to form a limiting space for limiting each of the conversion members.

7. The gimbal structure according to claim 1, wherein:
each of the conversion members further comprises an elastic member, the elastic member is configured to push the each of the conversion members so that the conversion members have a tendency to retract;
when the cam member drives any of the conversion members to extend out of the mounting surface, the conversion member is configured to overcome an elastic force and extend out of the mounting surface; and
when the cam member does not drive the conversion members, the conversion members are configured to retract below the mounting surface under an action of the elastic force.

8. The gimbal structure according to claim 7, wherein the elastic member is sleeved on each of the conversion members, one end of the elastic member abuts against the mounting surface, and the other end of the elastic member abuts against each of the conversion members.

9. The gimbal structure according to claim 1, further comprising a gimbal pressure block and a gimbal knob, wherein
one end of the gimbal body is provided with a second opening, and the gimbal pressure block is exposed at the second opening; and
a driving end of the gimbal knob is transmission-connected to the gimbal pressure block, and the gimbal knob is rotated to enable the gimbal pressure block to be engaged.

10. A photographic device, comprising:
the gimbal structure according to claim 1;
a quick-release plate clamped and fixed with the gimbal structure; and
a tripod detachably connected to the gimbal structure.
